(19) United States
(12) Patent Application Publication
(10) Pub. No.: US 2024/0345851 A1
(43) Pub. Date: Oct. 17, 2024

(54) CONFIGURATION OF USER INTERFACE FOR RISK ASSESSMENT VISUALIZATION

(71) Applicant: EQUIFAX INC., Atlanta, GA (US)

(72) Inventors: Warren du Preez, Melbourne (AU); Bowen Huang, Melbourne (AU)

(21) Appl. No.: 18/294,330

(22) PCT Filed: Aug. 1, 2022
(86) PCT No.: PCT/US2022/074389

§ 371 Date: Feb. 1, 2024

Related U.S. Application Data
(60) Provisional application No. 63/228,510, filed on Aug. 2, 2021.

(51) Int. Cl. G06F 9/451; G06Q 10/0635

(52) U.S. Cl. CPC G06F 9/451; G06Q 10/0635

(57) ABSTRACT

In some embodiments, a data visualization system accesses data entries associated with entities and obtained from multiple data sources. The data visualization system generates a classification map for the entities by classifying the entities into groups based on the data entries from the multiple data sources. The groups are arranged in the classification map according to values of the data entries of the entities. The data visualization system determines one or more metrics for the groups. The data visualization system further determines visualizations based on the classification map, each visualization representing a metric or the data entries from one of the data sources. The data visualization system generates, for inclusion in a user interface of the system, selectable interface elements configured for invoking an editing tool for updating the visualizations. The selectable interface elements for the visualizations are arranged in the respective visualizations according to the classification map.

### CROSS-REFERENCE TO RELATED APPLICATIONS

This claims the benefit and priority under 35 U.S.C. 119 (e) of U.S. Provisional Application No. 63/228,510, filed Aug. 2, 2021, and titled “Decision Maps Based on Self-Organizing Map,” the contents of which are herein incorporated by reference.

### TECHNICAL FIELD

The present disclosure relates generally to machine learning and artificial intelligence. More specifically, but not by way of limitation, this disclosure relates to presenting proper risk assessment visualization editing tools in a user interface based on grouping entities through machine learning techniques and using risk assessment data obtained from multiple data sources for these entities.

### BACKGROUND

With the rise of machine learning in automated decisioning and the increasing number of available data sources, the problem of how to combine multiple model predictions on access risks that are based on different sources of data in order to determine an effective strategy for access control is becoming increasing relevant and difficult as the number of scores to be combined grows. For example, for an online interactive computing environment, multiple user access risk scores may be generated based on data sources such as user profile information, user device behavioral information, third party assessment data, and online activity data. This poses the problem of how to use these risk scores together effectively in order to decide which user device to approve for accessing the online environment, and which to decline. This problem may arise in many different contexts too. For example, in a computing system where multiple components are to be selected to be integrated into the computing system to perform different functions, each component can be evaluated based on multiple metrics, such as stability, speed, capacity, and so on. These multiple metrics or scores for each component need to be combined to make decisions on which components to be selected for integrating into the computing system.

### SUMMARY

Certain embodiments involve presenting proper risk assessment visualization editing tools in a user interface based on grouping entities using risk assessment data obtained from multiple data sources. In one example, a computer-implemented method includes accessing data entries associated with a plurality of entities and obtained from a plurality of data sources and generating a classification map for the plurality of entities by classifying the plurality of entities into a plurality of groups based on the data entries from the plurality of data sources. The plurality of groups are arranged in the classification map according to values of the data entries of the plurality of entities. The method further includes determining one or more metrics for the plurality of groups, determining a plurality of visualizations based on the classification map, each visualization representing one of the one or more metrics or the data entries from one of the plurality of data sources, and generating, for inclusion in a user interface of the system, selectable interface elements configured for invoking an editing tool for updating the plurality of visualizations. The selectable interface elements for the plurality of visualizations are arranged in the respective visualizations according to the classification map.

In another example, a system includes a processing device and a non-transitory computer-readable medium communicatively coupled to the processing device. The processing device is configured to execute program code stored in the non-transitory computer-readable medium and thereby perform operations. The operations include accessing data entries associated with a plurality of entities and gathered from a plurality of data sources, and generating a classification map for the plurality of entities by classifying the plurality of entities into a plurality of groups based on the data entries from the plurality of data sources. The plurality of groups are arranged in the classification map according to values of the data entries of the plurality of entities. The operations further include determining one or more metrics for the plurality of groups, determining a plurality of visualizations based on the classification map, each visualization representing one of the one or more metrics or the data entries from one of the plurality of data sources, and generating, for inclusion in a user interface of the system, selectable interface elements configured for invoking an editing tool for updating the plurality of visualizations. The selectable interface elements for the plurality of visualizations are arranged in the respective visualizations according to the classification map.

In yet another example, a non-transitory computer-readable medium has program code that is stored thereon. The program code is executable by one or more processing devices for performing operations. The operations include accessing data entries associated with a plurality of entities and gathered from a plurality of data sources and generating a classification map for the plurality of entities by classifying the plurality of entities into a plurality of groups based on the data entries from the plurality of data sources. The plurality of groups are arranged in the classification map according to values of the data entries of the plurality of entities. The operations further include determining one or more metrics for the plurality of groups, determining a plurality of visualizations based on the classification map, each visualization representing one of the one or more metrics or the data entries from one of the plurality of data sources, and generating, for inclusion in a user interface, selectable interface elements configured for invoking an editing tool for updating the plurality of visualizations. The selectable interface elements for the plurality of visualizations are arranged in the respective visualizations according to the classification map.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is an example of a computing environment in which proper risk assessment visualization editing tools are created and presented in a user interface based on grouping entities using risk assessment data obtained from multiple data sources, according to certain aspects of the present disclosure.

FIG. 2 depicts an example of a flowchart for presenting proper risk assessment visualization editing tools in a user interface based on grouping entities using risk assessment data obtained from multiple data sources, according to certain aspects of the present disclosure.

FIG. 3 depicts an example of a structure of a self-organizing map (SOM), according to certain aspects of the present disclosure.

FIG. 4 depicts an example of a process of training the SOM model according to certain aspects of the present disclosure.

FIG. 5 depicts an example of a user interface for presenting visualizations using proper risk assessment visualization editing tools created based on grouping entities using risk assessment data from multiple data sources, according to certain aspects of the present disclosure.

FIG. 6 depicts an example of the user interface in FIG. 5 after feedback is received from a selectable interface element, according to certain aspects of the present disclosure.

FIG. 7 depicts another example of the user interface in FIG. 5 after feedback is received from some selectable interface elements, according to certain aspects of the present disclosure.

FIG. 8 depicts an example of a computing system for implementing certain aspects of the present disclosure.

### DETAILED DESCRIPTION

Certain aspects described herein are provided for presenting proper risk assessment visualization editing tools in a user interface based on grouping entities using risk assessment data for these entities obtained from multiple data sources. A risk assessment computing system can utilize a classification model trained to determine a classification map for entities by classifying the entities into groups based on multi-source multi-dimensional risk assessment data associated with the entities regarding accessing an interactive computing environment. The classification map allows intuitive visualizations of the multi-source multi-dimensional risk assessment data of the entities to be presented in a user interface. The visualizations can also be presented with selectable interface elements configured for invoking editing tools to edit or update the visualizations. The editing or updating of the visualization can facilitate decision making related to controlling access to the interactive computing environment by the respective entities.

For example, the risk assessment computing system can access risk assessment data (e.g., risk scores or risk indicators) of the entities obtained from different resources. The risk assessment data from different sources indicate the risks associated with granting access to an interactive computing environment to the respective entities from different perspectives. For example, the risk assessment data derived from transaction data may indicate the access risk associated with the entities based on their respective transactions. The risk assessment data obtained from another risk evaluation system may indicate the access risk associated with the entities according to the risk evaluation criterion utilized by the other risk evaluation system.

The risk assessment computing system can apply a classification model to classify the entities into groups based on risk assessment data associated with these entities that are obtained from the multiple data sources. The classification model can output a classification map which may be used to generate intuitive visualization for the risk assessment data and other metrics associated with the entities. For example, the risk assessment computing system can compute a performance metric for each group of entities measuring the performance of the entities in each group (such as resource utilization rate, timeliness of releasing occupied computing resources, etc.) when access is granted to the entities. The metric can include a metric that is mostly relied on when deciding whether to grant further access by the entities. In addition, the risk assessment computing system can compute a metric to measure the number of entities in each group which can help to assess the impact of an access control decision made for each group. The classification map can include multiple items, each representing a group of entities. The items are arranged in a two-dimensional space (e.g., in a rectangular grid). The positions of individual groups in the two-dimensional classification map are determined according to the values of the risk assessment data of the entities in respective groups.

The classification model used to generate the classification map can be an artificial neural network model such as self-organizing map (SOM) model. The SOM model can include a feature learning model used to produce a low-dimensional representation of higher dimensional data entries while retaining the topological structure of the data entries. The training of the SOM model can involve mapping the risk assessment data with n dimensions as an input space into a map space with two dimensions. For example, each risk assessment data with n variables may be represented as an input space with n dimensions. The map space may contain nodes that are arranged as a hexagonal or rectangular grid in a two-dimensional space. Each node in the map space is associated with a weight vector indicating the position of the node in the input space. While nodes in the map space stay fixed, training consists in moving the weight vectors toward the risk assessment data (e.g., reducing a distance metric such as Euclidean distance) without destroying the topology induced from the map space. After training, the map space can be used as the classification map to classify additional risk assessment data for the input space by finding the node with the closest weight vector (smallest distance metric) to the input space vector.

Based on the classification map and the calculated metrics, the risk assessment computing system can generate a visualization for each of the metrics and the risk assessment data from each data source. Each visualization can include a two-dimensional arrangement of items, each item representing one of the groups. These multiple visualizations can have a correspondence relationship in that each item in one visualization has a corresponding item in other visualizations. These visualizations can be presented in a user interface of the system.

In addition to the visualizations, the risk assessment computing system can further generate selectable interface elements for invoking editing tools for updating the visualizations. The selectable interface elements can include those associated with individual visualization or items thereof and those applicable to multiple visualizations. For example, the selectable interface elements associated with a visualization can be arranged in the user interface according to the classification map. If feedback (e.g., a selection or a click) is received from a selectable interface element in the user interface, the system can determine the status of the items in the visualizations according to the feedback and update the visualizations according to the determined status. For example, if an item (representing one group of entities) in one of the visualizations has a status reflecting the group of entities are granted access and the selectable interface element associated with the item is clicked or otherwise activated, the system can determine that the group associated with the selected item should be denied access. Based on the updated status, the system can invoke an editing tool to update the visualization to reflect the status change. Access control decisions can consequently be generated for the entities based on the determined status of the items. If a selectable interface element is applicable to multiple visualizations, the system can use the editing tool to update the multiple visualizations based on the feedback or input received at the selectable interface element.

In some examples, risk assessment data from a particular data source may be given more weight than risk assessment data from other data sources. For example, when determining whether to grant access to entities, the risk scores generated based on transaction data may be given more weight than the risk scores determined by another risk evaluation system. In these cases, the classification model can be trained to give more weight to data from one or more data sources than other data sources. In the above example, the risk scores generated based on transaction data may be emphasized more in training the classification model by giving a higher weight to the corresponding risk assessment data. The classification model can also be re-applied to the weighted risk assessment data to re-classify the entities. For example, the values of the risk scores based on transaction data may be scaled to be within a range larger than the range of the risk scores from other data sources. In this case, the scaled risk assessment data can be used accordingly in the process of determining the distances between the weight vector of the nodes and the input space. That is, the process of classifying entities with the classification model may be more influenced by the scaled risk assessment data based on the transaction data than other data sources. As a result, the classification model can generate an updated classification map for updating the visualizations.

Generating the visualizations in a user interface in the above-described manner improves the functionality of the interface by, for example, providing the proper editing tools to a user, thereby allowing a user to quickly create and adjust the visualizations to facilitate the decision-making process. Even novice users without much knowledge about the user interface and the underlying risk assessment data and other associated data can quickly and accurately select the right editing tools to facilitate the decision process. These techniques, therefore, decrease the amount of time or effort involved in the decision-making process concerning the access control of the online environment.

In addition, the proposed technology provides a conceptual framework and interactive tool for creating, visualizing, and making ongoing adjustments to strategies that are based on multiple scores. The interactive tool leverages the machine learning techniques, such as self-organizing map algorithm, to provide a representation of higher-dimensional information in two dimensions while retaining the topology of the original space. For example, if an entity has five scores, each entity will have a score vector in five dimensions. The proposed technology can provide a representation of the non-visualizable five-dimensional entity/component information to two-dimensional information, which is visualizable. Using this resulting two-dimensional map as a base, different kinds of entity information may be presented visually in a structured and easy-to-understand way, and formation and adjustment of strategies that involve selecting certain groups of entities/components for certain purposes can be informed by changes in the displayed information that occurs when different regions are selected.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Machine-Learning Operations

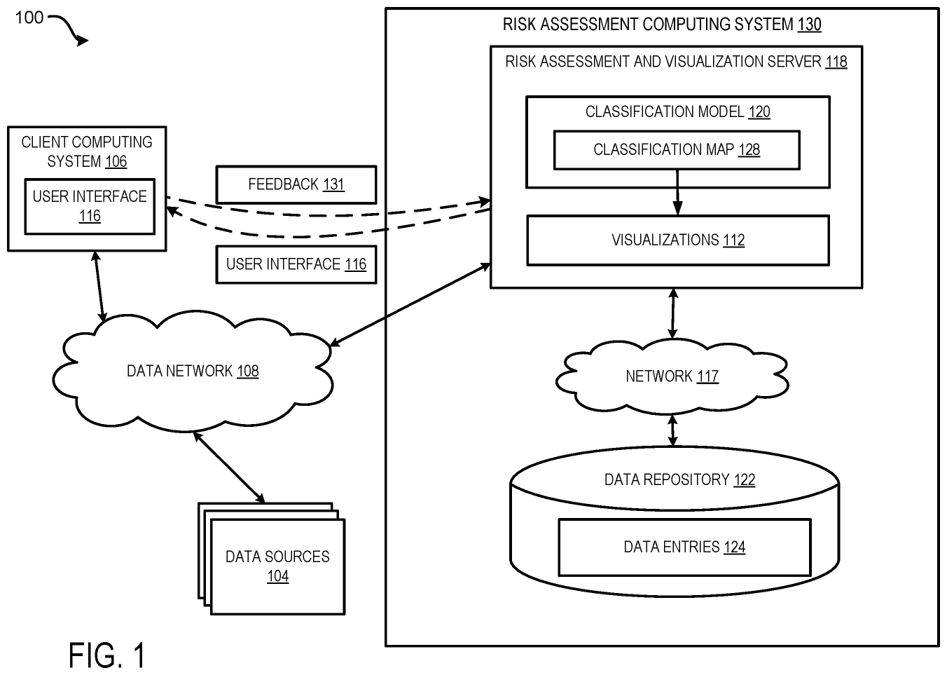

Referring now to the drawings, FIG. 1 is an example of a computing environment in which proper risk assessment visualization editing tools are created and presented in a user interface based on grouping entities using multi-dimensional risk assessment data obtained from multiple data sources, according to certain aspects of the present disclosure.

In various embodiments, the computing environment 100 includes a risk assessment computing system 130 and one or more client computing systems 106 (which may be referred to herein individually as a client computing system 106 or collectively as the client computing systems 106). One or more computing devices can be used to implement the risk assessment computing system 130. For instance, the risk assessment computing system 130 can include a single computing device, a group of servers, or other computing devices arranged in a distributed computing architecture, etc. In the example shown in FIG. 1, the risk assessment computing system 130 employs a risk assessment and visualization server 118 to implement the functionality for risk assessment. A client computing system 106 may be associated with clients, such as resource providers, that use the risk assessment computing system 130 to make decision on whether to grant access to an interactive computing environment hosted or otherwise provided by the client. For example, the client may be an online computing resource provider hosting online computing resources such as virtual machines, online storage, or network resources. In other examples, the client may be a bank or a financial institution. The client computing system 106 can be any suitable device that is capable of displaying the user interface 116. For non-limiting examples, a client computing system 106 may be a server computer, a desktop computer, a laptop computer, a smartphone, a tablet, a smart wearable, or other types of user device.

The client computing system 106 or another system associated with the client can execute instructions that provide an interactive computing environment accessible to user computing systems (not shown in FIG. 1). Examples of the interactive computing environment include a mobile application specific to a particular client computing system 106, a web-based application accessible via a mobile device, etc. The executable instructions are stored in one or more non-transitory computer-readable media.

The client computing system 106 or another system can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system to access various functions of the interactive computing environment. For instance, the interactive computing environment may transmit data to and receive data from a user computing system to shift between different states of the interactive computing environment, where the different states allow one or more electronics interactions between the user computing system and the client computing system 106 to be performed.

In some examples, a client computing system 106 or another system associated with the client may include other computing resources associated therewith (e.g., not shown in FIG. 1), such as server computers hosting and managing virtual machine instances for providing cloud computing services, server computers hosting and managing online storage resources for users, server computers for providing database services, and others. The interaction between the user computing system and the client computing system 106 may be performed through graphical user interfaces presented by the client computing system 106 to the user computing system, or may be performed through application programming interface (API) calls or web service calls.

A user computing system can include any computing device or other communication device operated by a user, such as a consumer or a customer. The user computing system can include one or more computing devices, such as laptops, smartphones, and other personal computing devices. A user computing system can include executable instructions stored in one or more non-transitory computer-readable media. The user computing system can also include one or more processing devices that are capable of executing program code to perform operations described herein. In various examples, the user computing system can allow a user to access certain online services from a client computing system or other computing resources, to engage in mobile commerce with a client computing system 106, to obtain controlled access to electronic content hosted by the client computing system 106, etc.

For instance, the user can use the user computing system to engage in an electronic interaction with a client computing system 106 via an interactive computing environment. An electronic interaction between the user computing system and the client computing system 106 can include, for example, the user computing system being used to request online storage resources managed by the client computing system 106, acquire cloud computing resources (e.g., virtual machine instances), and so on. An electronic interaction between the user computing system and the client computing system 106 can also include, for example, query a set of sensitive or other controlled data, access online financial services provided via the interactive computing environment, submit an online credit card application or other digital application to the client computing system 106 via the interactive computing environment, operating an electronic tool within an interactive computing environment hosted by the client computing system (e.g., a content-modification feature, an application-processing feature, etc.).

In some aspects, an interactive computing environment implemented through a client computing system 106 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and interaction management workflows, electronic fund transfers, etc. A user computing system can be used to request access to the interactive computing environment provided by the client computing system 106, which can selectively grant or deny access to various electronic functions. Based on the request or other triggering events, the client computing system 106 can use the risk assessment and visualization server 118 for risk assessment. Based on the risk assessment facilitated by the risk assessment and visualization server 118, the client computing system 106 can determine whether to grant the access request of the user computing system to certain features of the interactive computing environment.

To facilitate the risk assessment, the risk assessment computing system 130 can access data entries 124 about entities that are obtained from multiple data sources 104 via a data network 108. The entities can include individuals or organizations, such as users of the online computing resource providers, customers or consumers of banks, etc. In some examples, the data entries 124 can include risk assessment data, including risk scores, risk indicators or like. The risk assessment data can be stored in a data repository 122 that is accessible by the risk assessment and visualization server 118 via a network 117.

For example, the data repository 122 can be network-attached storage units that may store different types of data organized in different ways and from a variety of data sources. For example, the network-attached storage unit may include storage other than primary storage located within the risk assessment and visualization server 118 that is directly accessible by processors located therein. In some aspects, the network-attached storage unit may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory, or memory devices.

The data sources 104 can include data that has been generated about the entities based on interactions of the user computing systems associated with the entities with the client computing system or another system associated with the client. For example, if the client is an online resource provider, the data sources can include application information submitted by users to the resource provider, behavioral information about user devices logged during the interactions by the user devices with the resource provider system and transactions performed by the user devices with the client computing system or another system associated with the client. If the client is a bank, the data sources can include application information submitted by bank customers to the bank, behavioral information about customers logged during the interactions by the customers with the bank system and transactions performed by the customer with the client computing system or another system associated with the client.

These data sources may also include risk assessment data generated by the client computing system or another system associated with the client based on the application data or behavioral data. The data sources 104 can also include risk assessment data generated by third party risk evaluation systems. For example, the data source can include risk scores determined according to network security standards used in the industry, credit scores obtained from credit bureau, and so on. In another example, the data source can include risk assessment data determined by a risk evaluation system associated with a third-party service provider that indicates the access risk associated with the entities. The risk assessment data may indicate the access risk associated with the entities according to the risk evaluation criterion utilized by the risk evaluation system of the third-party service provider and based on data not available to the client computing system 106.

The risk assessment data from the data sources 104 indicate the risks associated with granting access to the interactive computing environment to the respective entities from different perspectives. For example, the risk assessment data derived from transaction data may indicate the access risk associated with the entities based on their respective transactions. The risk assessment data obtained from another risk evaluation system may indicate the access risk associated with the entities according to the risk evaluation criterion utilized by the other risk evaluation system.

The risk assessment computing system 130 can utilize the risk assessment and visualization server 118 to train and use a classification model 120, such as a SOM model, to determine a classification map 128 for entities by classifying the entities into groups based on the risk assessment data associated with the entities. The classification map 128 can include multiple items. Each item represents a group of entities, and the items are arranged in a two-dimensional space (e.g., in a rectangular grid). The positions of individual groups in the two-dimensional classification map are determined according to the values of the risk assessment data of the entities in respective groups. Based on the classification map 128, the risk assessment and visualization server 118 can generate various visualizations 112 for the risk assessment data and other metrics associated with the risk assessment data.

In some examples, the visualizations 112 can include a graphical representation of the data entries 124. The visualizations 112 can also include a graphical representation of a performance metric for each group of entities measuring the performance of the entities in each group (such as resource utilization rate, timeliness of releasing occupied computing resources, etc.) when access is granted to the entities. The performance metric can include a metric that is mostly relied on when deciding whether to grant further access by the entities. In addition, the risk assessment computing system can compute a metric to measure the number of entities in each group which can help to assess the impact of an access control decision made for each group.

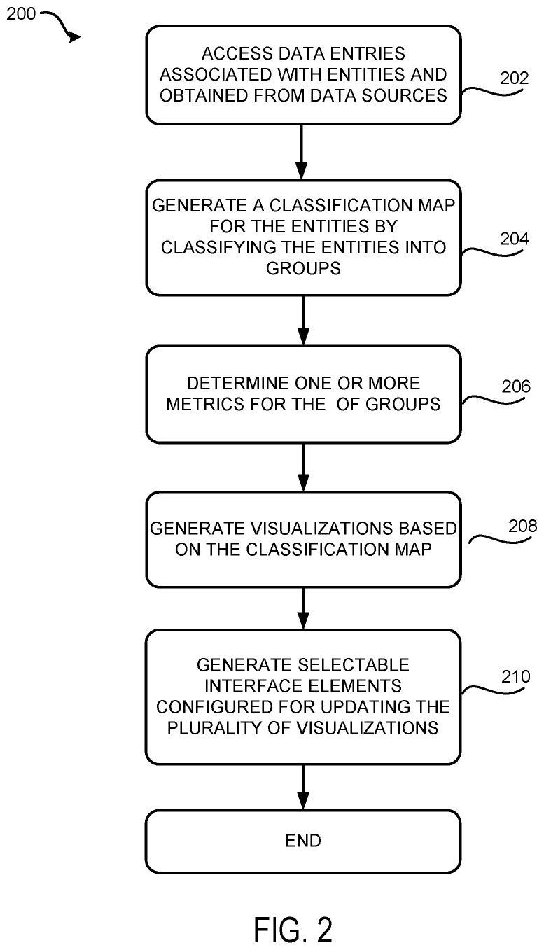

The risk assessment and visualization server 118 can also transmit the visualizations 112 to the client computing system 106 to be presented in a user interface 116 on the client computing system 106. The visualizations 112 can also be presented with selectable interface elements configured for invoking the editing tools to edit or update the visualizations 112. The editing or updating of the visualization can facilitate decision making for the clients related to controlling access to interactive computing environment by the respective entities. The selectable interface elements can include those associated with the individual visualizations 112 or items thereof and those applicable to multiple visualizations 112. For example, the selectable interface elements associated with one of the visualizations 112 can be arranged in the user interface 116 according to the classification map 128. Also, feedback 131 (e.g., clicking or selecting the selectable interface elements) can be received from the client computing systems 106 through the user interface 116. Based on the feedback, the risk assessment and visualization server 118 can update or edit the visualizations 112. The risk assessment computing system 130 can further determine the status of the items in the visualizations according to the feedback 131 and update the visualizations 112 according to the determined status. For example, if an item (representing one group of entities) in one of the visualizations has a status reflecting the group of entities are granted access and the selectable interface element associated with the item is subsequently clicked or otherwise activated, the risk assessment computing system 130 can determine that the group associated with the selected item should be denied access. Based on the updated status, the risk assessment and visualization server 118 can invoke an editing tool to update the visualization to reflect the status change. Access control decisions can consequently be generated for the entities based on the determined status of the items. If a selectable interface element is applicable to multiple visualizations, the risk assessment computing system 130 can use the editing tool to update the multiple visualizations 112 based on the feedback 131 from the received selectable interface element. Additional details regarding creating and presenting proper risk assessment visualization editing tools based on grouping entities using multi-dimensional risk assessment data obtained from multiple data sources are provided below with regard to FIGS. 2-7.

If a user computing system is granted access permission to the interactive computing system, the access permission can include, for example, cryptographic keys used to generate valid access credentials or decryption keys used to decrypt access credentials. The client computing system 106 can also allocate resources to the user and provide a dedicated web address for the allocated resources to the user computing system, for example, by adding it in the access permission. With the obtained access credentials and/or the dedicated web address, the user computing system can establish a secure network connection to the computing environment hosted by the client computing system 106 and access the resources via invoking API calls, web service calls, HTTP requests, or other proper mechanisms.

Each communication within the operating environment 100 may occur over one or more data networks, such as a data network 108, a network 117 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the client computing system 106 and the risk assessment and visualization server 118, may be instead implemented in a signal device or system.

FIG. 2 depicts an example of a flowchart for presenting proper risk assessment visualization editing tools in a user interface based on grouping entities using risk assessment data obtained from multiple data sources, according to certain aspects of the present disclosure. One or more computing devices (e.g., the risk assessment computing system 130 or more specifically the risk assessment and visualization server 118) implement operations depicted in FIG. 2 by executing suitable program code (e.g., the classification model 120). For illustrative purposes, the process 200 is described with reference to certain examples depicted in the figures. Other implementations, however, are possible.

At block 202, the process 200 involves the risk assessment computing system 130 accessing data entries 124 associated with multiple entities and obtained from multiple data sources 104. The data entries 124 can include data obtained from multiple data sources 104. The data sources 104 can include data that the client has generated about the entities based on interactions of the user computing systems associated with the entities with the client computing system or another system associated with the client. For example, if the client is an online resource provider, the data sources can include application information submitted by users to the resource provider, behavioral information about user devices logged during the interactions by the user devices with the resource provider system, and transactions performed by the user devices with the client computing system or another system associated with the client. If the client is a bank, the data sources can include application information submitted by bank customers to the bank, behavioral information about customers logged during the interactions of the user computing systems with the bank system and transactions performed by the customer with the client computing system or another system associated with the client. These data sources may also include risk assessment data generated by the client computing system or another system associated with the client based on the application data or behavioral data. The data sources 104 can also include risk assessment data generated by third party risk evaluation systems. For example, the data source can include risk scores determined according to network security standards used in the industry, credit scores obtained from credit bureau, and so on. In another example, the data source can include risk assessment data determined by a risk evaluation system associated with a third-party service provider that indicates the access risk associated with the entities. The risk assessment data may indicate the access risk associated with the entities according to the risk evaluation criterion utilized by the risk evaluation system of the third-party service provider and based on data not available to the client computing system 106.

The risk assessment data from the data sources 104 indicate the risks associated with granting access to the interactive computing environment to the respective entities from different perspectives. For example, the risk assessment data derived from transaction data may indicate the access risk associated with the entities based on their respective transactions. The risk assessment data obtained from another risk evaluation system may indicate the access risk associated with the entities according to the risk evaluation criterion utilized by the other risk evaluation system. In some examples, the data entries 124 can be formatted as a table having multiple rows with one row representing one entity. Each row can include multiple columns representing the risk scores from the multiple data sources and other data associated with the entity. The table is used herein as an example for illustration purposes and should not be construed as limiting. Other data structures other than a table can also be used to organize the data entries 124.

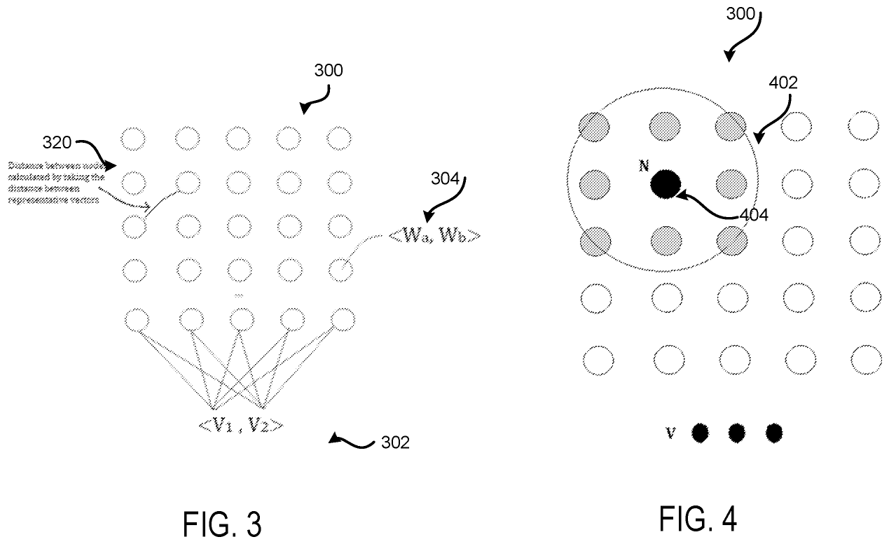

At block 204, the process 200 involves the risk assessment computing system 130 generating a classification map 128 for the multiple entities by classifying the multiple entities into multiple groups based on the data entries 124 from the multiple data sources 104. In some examples, the risk assessment computing system 130 can use a classification model 120 to generate a classification map 128 for the multiple entities by classifying the multiple entities into multiple groups based on the data entries from the multiple data sources 104. The classification model 120 used to generate the classification map can be an artificial neural network model such as the self-organizing map (SOM) model. The classification model 120 (e.g., SOM model) can include a feature learning model used to produce a low-dimensional representation of higher dimensional data entries while retaining the topological structure of the data entries. The risk assessment computing system 130 can apply the SOM model to classify the entities into groups based on risk assessment data from multiple data sources 104. FIGS. 3 and 4 show examples of model training and classifying input data according to certain aspects of the present disclosure.

The classification model 120 can output a classification map 128 based on the classification, which may be used to generate intuitive visualization for the risk assessment data and other metrics associated with the entities. The classification map 128 can include multiple items, each representing a group of entities from the multiple groups of entities. The items are arranged in a two-dimensional space (e.g., in a rectangular grid). The positions of individual groups in the two-dimensional classification map are determined according to the values of the risk assessment data of the entities in their respective groups.

At block 206, process 200 involves the risk assessment computing system 130 determining one or more metrics for the multiple groups. For example, the risk assessment computing system 130 can use a performance metric for each group of entities that measures the performance of the entities in each group when access is granted to the entities. Examples of the performance metric can include, but are not limited to, resource utilization rate, timeliness of releasing occupied computing resources, default rate. The determined metric can include a metric that is mostly relied on or has the highest weight when deciding whether to grant further access by the entities. In addition, the risk assessment computing system can use a metric to measure the number of entities in each group which can help to assess the impact of an access control decision made for each group.

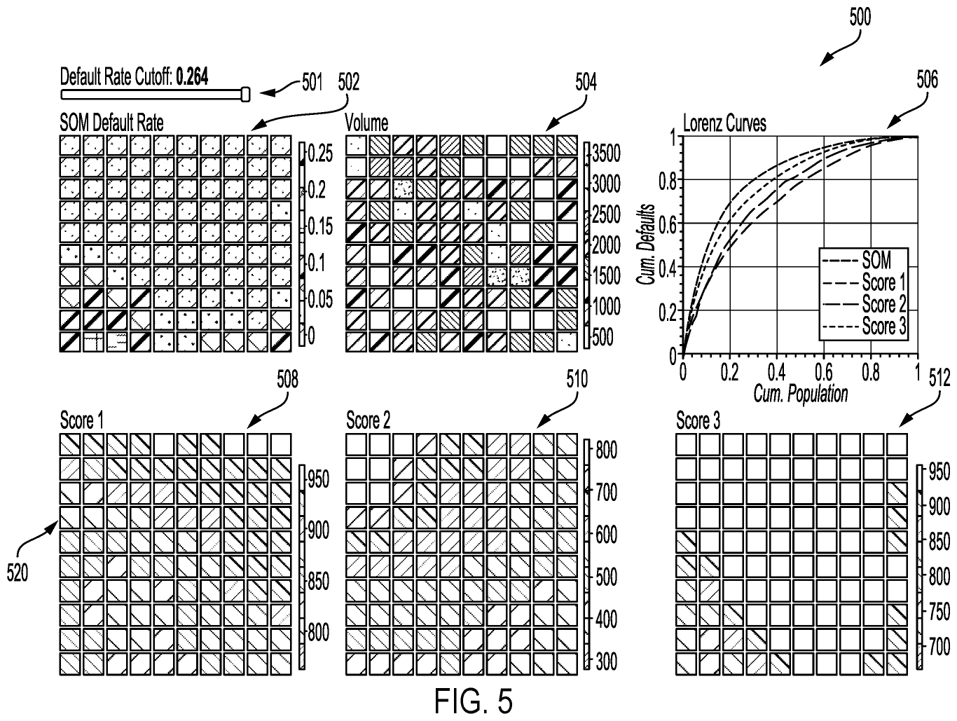

At block 208, the process 200 involves the risk assessment computing system 130 generating multiple visualizations based on the classification map, each visualization representing a metric or the data entries from one of the multiple data sources. In some examples, the risk assessment computing system 130 can generate a visualization for each of the metrics and the risk assessment data from each data source based on the classification map 128 and the calculated metrics. Each visualization can include a two-dimensional arrangement of items, each item representing one of the groups. These multiple visualizations can have a one-to-one correspondence relationship in that each item in one visualization has a corresponding item in other visualizations. These visualizations can be presented in a user interface 116. Examples of the visualizations presented in a user interface are shown in FIGS. 5-7.

At block 210, the process 200 involves the risk assessment computing system 130 generating, for inclusion in a user interface of the system, selectable interface elements configured for invoking an editing tool for updating the multiple visualizations. The selectable interface elements can include those associated with individual visualization or items thereof and those applicable to multiple visualizations. The selectable interface elements associated with visualization can be arranged in the user interface according to the classification map 128.

The risk assessment computing system 130 can receive feedback 131 from a selectable interface element corresponding to one item in one of the visualizations 112 in the user interface 116 and update items in the multiple visualizations that correspond to the one item according to the received feedback. Based on the status of the items in the visualization, the risk assessment computing system 130 can generate access control decisions for multiple entities. For example, if feedback 131 (e.g., a selection or a click) is received from a selectable interface element in the user interface 116, the risk assessment computing system 130 can determine the status of the items in the visualizations 112 according to the feedback 131 and update the visualizations 112 according to the determined status. For example, if an item (representing one group of entities) in one of the visualizations 112 has a status reflecting the group of entities are granted access and the selectable interface element associated with the item is subsequently clicked or otherwise activated, the system can determine that the group associated with the selected item should be denied access. Based on the updated status, the risk assessment computing system 130 can invoke an editing tool to update the visualization to reflect the status change. Access control decisions can consequently be generated for the entities based on the determined status of the items. If a selectable interface element is applicable to multiple visualizations 112, the risk assessment computing system 130 can use the editing tool to update the multiple visualizations 112 based on the feedback 131 or input received at the selectable interface element. In other examples, the risk assessment computing system 130 can generate, for inclusion in the user interface 116, additional selectable interface elements configured for invoking an editing tool for updating the multiple visualizations 112, wherein each of the additional selectable interface elements corresponds to one of the multiple data sources 104.

FIG. 3 depicts an example of a structure of self-organizing map (SOM) according to certain aspects of the present disclosure. The structure involves an SOM model producing a low-dimensional representation of higher dimensional data entries while retaining the topological structure of the data entries 124. The structure can include several nodes to form a two-dimension map space 300 using input vectors 302. The map space 300 may be a hexagonal or rectangular grid in the two-dimensional space. The SOM model can involve mapping the risk assessment data in an n-dimension input space onto the two-dimension map space 300. In some examples, the input vectors 302 are initialized either to small random values or sampled evenly from the subspace spanned by the two largest principal component eigenvectors. Alternatively, or additionally, the input vectors 302 can be sampled from the available input data or use all the available input data. Each node in the map space 300 is associated with a weight vector 304, indicating the position of the node in the input space. While nodes in the map space 300 stay fixed, the training process consists in moving the weight vectors 304 toward the data entries by reducing a distance (e.g., such as Euclidean distance) between the weight vectors 304 of two nodes in the input space without destroying the topology induced from the map space 300.

FIG. 4 depicts an example of a process of training SOM model according to certain aspects of the present disclosure. For example, data entries with n variables represent points in the n-dimension input space and can be input into a map space 300. Distances between a data entry in the input space and the weight vector 304 of each node in map space 300 can be calculated. The node whose weight vector 304 is closest to the data entry is called the best matching unit (BMU) 404. The BMU 404 and nodes close to the BMU 404 can be used to form a best matching neighborhood 402 in the map space 300. The weight vectors 304 of the BMU 404 and nodes close to the BMU 404 are adjusted towards the input vector 302. The radius of neighborhood 402 can be adjusted throughout the training process. By repeatedly inputting each data entry into the map space 300 in the training process, the classification map 128 can be generated and used to determine the visualizations 112. The updating equation for a target node with weight vector can be formulated as equation (1) shown below:

$$W ( t + 1 ) = W ( t ) + Θ ( t ) L ( t ) ( V ( t ) - W ( t ) ) \qquad ( 1 )$$

where W represents a target weight vector of a target node; t represents the current iteration; V represents the input vector 302; Θ(t) represents the level of influence; and L represents the learning rate. The level of influence can be determined based on distance from the BMU (d), size of the neighborhood window (σ), and time (t). The level of influence Θ(t) can be formulated as equation (2) shown below:

$$Θ ( t ) = {e}^{- \frac{{d}^{2}}{2 {σ}^{2} ( t )}} \qquad ( 2 )$$

At every iteration of the training process, the neighborhood window may be reduced using a decay function, such as exponential decay. The training process can be alternatively changed to a similar decay function as equation (3) shown below:

$$σ ( t ) = {σ}_{0} {e}^{- \frac{t}{λ}} \qquad ( 3 )$$

In some examples, the risk assessment data in the data entries (e.g., risk scores) obtained from a particular data source 104 may be given more weight than other risk assessment data from other data sources 104. For example, risk scores obtained based on transaction data are given more weight than the other risk scores. In these cases, the classification model 120 can be trained to give more weight to risk scores from one or more data sources 104 than other data sources 104. In the above example, the risk scores generated based on transaction data may be emphasized more in training the classification model 120 by giving a higher weight to the corresponding risk assessment data. To do so, scaled risk assessment data can be used in the process of determining the distances between the weight vector of the nodes and the input space. That is, the process of classifying entities with the classification model may be more influenced by the scaled risk assessment data based on the transaction data than other data sources. As a result, the classification model can generate an updated classification map for updating the visualizations.

For example, the values of the risk scores based on transaction data may be scaled to be within a range larger than the range of the risk scores from other data sources. For example, in order to emphasize the risk scores from transaction data over others through the SOM model training process, the SOM model can scale the risk scores from transaction data in such a way as to reflect the desired emphasis. For example, the risk scores from transaction data can be scaled to be values between 0 and 1000, and other risk scores can be scaled to be values between 0 to 10. In this way, risk scores from transaction data can contribute more to the overall distance than other risk scores during the training process.

FIG. 5 depicts an example of a user interface 500 for presenting visualizations using proper risk assessment visualization editing tools created based on grouping entities using risk assessment data from multiple data sources, according to certain aspects of the present disclosure. Each of the visualizations 502, 504, 508-512 are generated based on a classification map that includes multiple items arranged in a two-dimension grid. The classification map can be generated using the SOM algorithm by the classification model 120. The items in the classification map correspond to respective items in each of the visualizations 502, 504, 508, 510, and 512.

Among the visualizations shown in the user interface 500, each of visualizations 508-512 shows the risk scores from respective data sources. In other words, visualization 508 shows the risk scores from source 1; visualization 510 shows the risk scores from source 2; visualization 512 shows the risk scores from source 3. These visualizations can also be referred to as score visualizations in this example. Each score visualization includes an array of items 520 arranged in a two-dimension grid. Each item 520 in the score visualization represents a group of entities determined by the classification model 120 and has an associated value calculated based on the risk scores for the entities in the corresponding group. For example, the value of an item can be calculated as the average value of the risk scores of the entities in the corresponding group.

Visualizations 502 and 504 are visualizations generated for metrics determined in block 206 and thus can be referred to as metric visualizations. For example, the metric visualization 502 is generated for the metric of a default rate (e.g., a rate that a user computing device fails to return the allocated computing resources on time, a rate that an individual fails to make payments on a loan, etc.). Each item in the metric visualization is associated with a default rate calculated as the average default rate for the entities in the entity group corresponding to the item. In the example shown in FIG. 5, metric visualization 504 is generated for the metric of user population, which represents the number of entities in each group. As such, each item in metric visualization 504 has a value equal to the number of entities in the corresponding group. The items in the visualizations 502, 504, and 508-512 have one-to-one correspondence in that an item at the same location in different visualizations represent the same group of entities. For instance, the 5^{th} item in the second row of the visualizations 502, 504, and 508-512 represents the same group.

Each of the items in each of the visualizations can be associated with a selectable interface element, which can be overlaid over the item. The selectable interface element, once selected, can cause the status of the item to be changed and thus presented differently, such as using a different color or a different pattern. The status of an item may indicate whether the group of entities represented by the item is granted access or not. In addition, since the items of the visualizations have the one-to-one correspondence, the selectable interface elements for the corresponding items in different visualizations can be configured to be connected. As such, if one selectable interface element is activated in one of the visualizations, the connected selectable interface elements in other visualizations are also activated and thus the statuses and looks of the corresponding items in those visualizations are also changed.

The user interface 500 further includes a selectable interface element 501 that is not associated with the items in the visualizations. The selectable interface element 501 can be used to set a criterion for one of the metrics represented using the metric visualizations so that items (thus the corresponding group of entities) are selected or de-selected based on whether the values of the items in the metric visualization meets the criterion. For example, the selectable interface element 501 can be used to set a default rate threshold so that items in the metric visualization 502 that have an average default rate below the threshold are automatically selected. The entities corresponding to the selected items can be granted access to the interactive computing environment.

The user interface 500 further includes a diagram 506 configured to show the relationship between the metrics, the default rate and the population in this example. This diagram can be used to show the impact of default rate threshold on the number of selected and de-selected entities to facilitate the decision process.

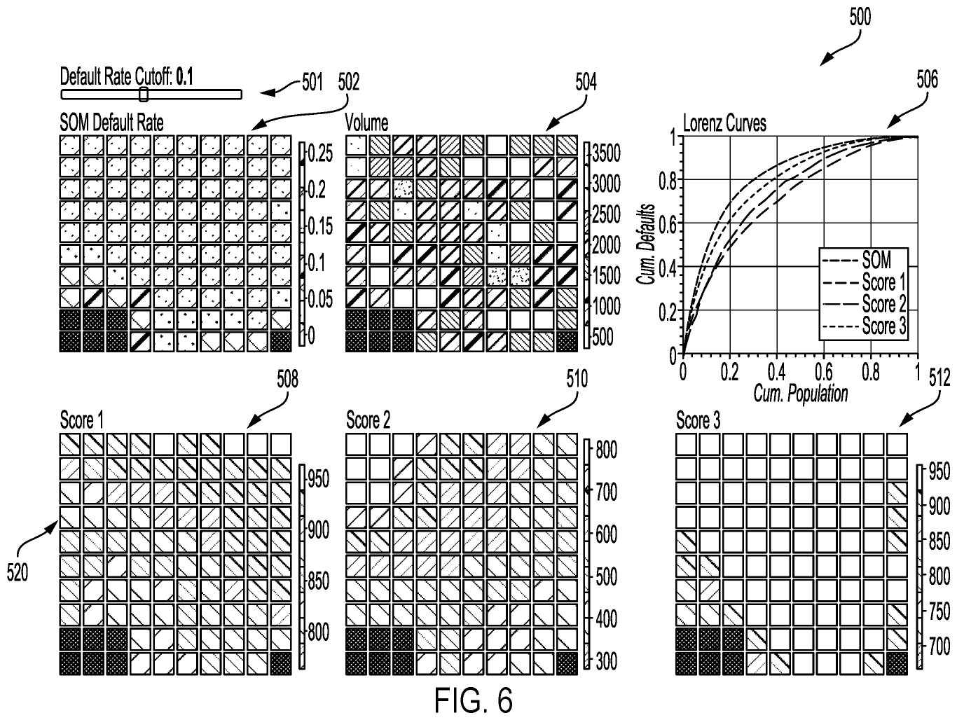

FIG. 6 depicts an example of the user interface 500 after the selectable interface element 501 is set to a different value, according to certain aspects of the present disclosure. In this example, the selectable interface element 501 is changed from a previous value 0.264 to a new value 0.1. This change is received or generated by the client computing system 106 as feedback 131. In response, risk assessment computing system 130 updates all the visualizations in the user interface to change the status of the items in each visualization and the presentation of the items. In the example shown in FIG. 6, by resetting the default rate threshold value to 0.1, at least six items at the lower left corner of the visualizations become unselected (because they do not meet the criterion) and thus the risk assessment computing system 130 renders these items in a grayed-out color.

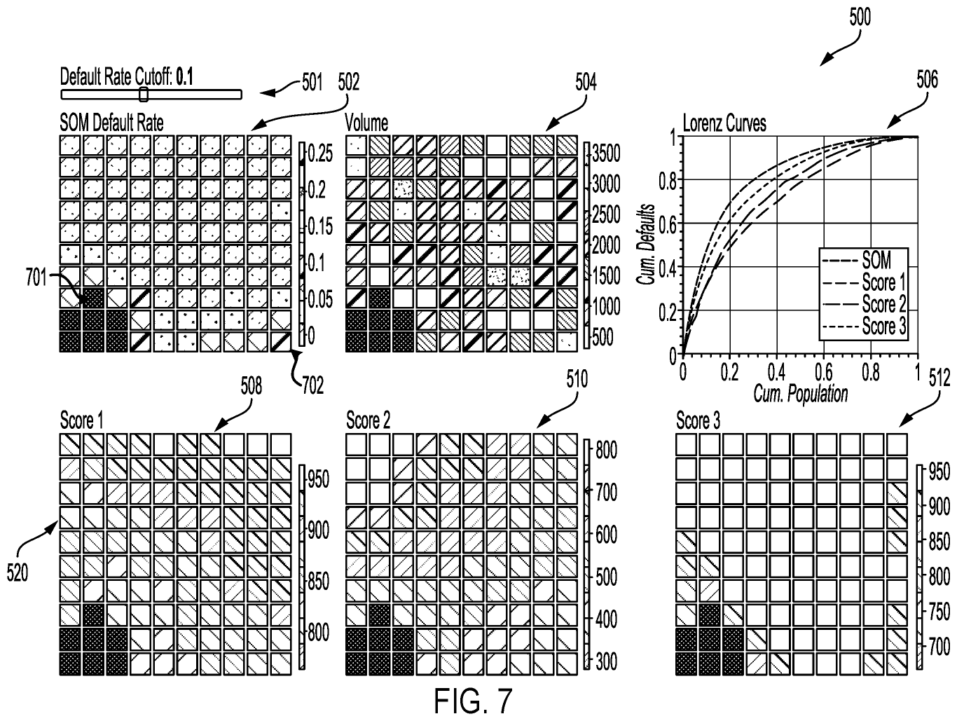

FIG. 7 depicts a further example of the user interface 500 after the selectable interface elements associated with certain items are activated or de-activated, according to certain aspects of the present disclosure. In this example, the selectable interface element 701 is de-selected and the selectable interface element 702 is selected. The operations are received or generated at the client computing system 106 as feedback 131. In response, risk assessment computing system 130 updates all the visualizations in the user interface to change the status of the selected and de-selected items in each visualization. The presentation of the selected and de-selected items, such as color and look, is also updated. In the example shown in FIG. 7, the selectable interface element 701 was de-selected and thus the color of the associated item is grayed out. The selectable interface element 702 is selected and the colors of the associated item in the visualizations are changed to a value reflecting its associated values in the respective visualizations.

The visualizations and selectable interface elements shown in FIGS. 5-7 are for illustration only and should not be construed as limiting. Additional visualizations or selectable interface elements may be shown in the user interface. For example, a slider interface element can be added under each of the visualizations, to allow for a hard cutoff with respect to each value represented by the visualizations.

In another example, a slider interface element corresponding to each component risk score can be added. The value set on the slider indicates a weight associated with the corresponding risk score. These weights can be used to create a new visualization representing the weighted average of the component risk scores in each group. This new weighted-sum visualization could then be used as a guide in making adjustments to the automated cutoff (which is set by the slider 501 in the example user interface 500), rather than using the component scores separately to guide such adjustments.

While in the above, the proposed technology in an access control context is described, the technology proposed herein is not limited to such a specific context. For example, the technology proposed herein can also be used for computing system integration where multiple components are to be selected to be integrated into the computing system to perform different functions. Each component can be evaluated based on multiple metrics, such as stability, speed, capacity, and so on. These multiple scores for each component need to be combined to make decisions on which components to be selected for integrating into the computing system.

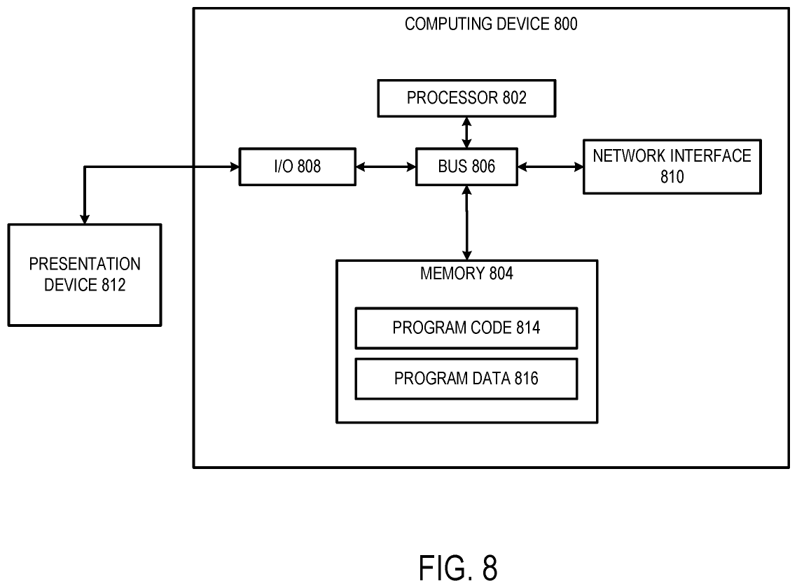

FIG. 8 depicts an example of a computing system for implementing certain aspects of the present disclosure. The implementation of computing system 800 could be used for one or more of a risk assessment computing system 130 or a client computing system 106. In other embodiments, a single computing system 800 having devices similar to those depicted in FIG. 8 (e.g., a processor, a memory, etc.) combines one or more operations and data stores depicted as separate systems in FIG. 1.

The depicted example of a computing system 800 includes a processor 802 communicatively coupled to one or more memory devices 804. The processor 802 executes computer-executable program code stored in a memory device 804, accesses information stored in the memory device 804, or both. Examples of the processor 802 include a microprocessor, an application-specific integrated circuit (“ASIC”), a field-programmable gate array (“FPGA”), or any other suitable processing device. The processor 802 can include any number of processing devices, including a single processing device.

A memory device 804 includes any suitable non-transitory computer-readable medium for storing program code 814, program data 816, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 800 executes program code 814 that configures the processor 802 to perform one or more of the operations described herein. Examples of the program code 814 include, in various embodiments, the insight visualization module 110 by the data visualization system 102, or other suitable applications that perform one or more operations described herein (e.g., one or more development applications for configuring the client computing system 106). The program code may be resident in the memory device 804 or any suitable computer-readable medium and may be executed by the processor 802 or any other suitable processor.

In some embodiments, one or more memory devices 804 stores program data 816 that includes one or more datasets and models described herein. Examples of these datasets include interaction data, performance data, etc. In some embodiments, one or more of data sets, models, and functions are stored in the same memory device (e.g., one of the memory devices 804). In additional or alternative embodiments, one or more of the programs, data sets, models, and functions described herein are stored in different memory devices 804 accessible via a data network. One or more buses 806 are also included in the computing system 800. The bus 806 communicatively couples one or more components of a respective one of the computing system 800.

In some embodiments, the computing system 800 also includes a network interface device 810. The network interface device 810 includes any device or group of devices suitable for establishing a wired or wireless data connection to one or more data networks. Non-limiting examples of the network interface device 810 include an Ethernet network adapter, a modem, or the like. The computing system 800 is able to communicate with one or more other computing devices via a data network using the network interface device 810.

The computing system 800 may also include a number of external or internal devices, a presentation device 812 with an input device. For example, the computing system 800 is shown with one or more input/output (“I/O”) interfaces 808. An I/O interface 808 can receive input from input devices or provide output to output devices. A presentation device 812 can include any device or group of devices suitable for receiving visual, auditory, or other suitable input that controls or affects the operations of the processor 802. Non-limiting examples of the presentation device 812 include a touchscreen, a mouse, a keyboard, a microphone, a separate mobile computing device, etc. A presentation device 812 can include any device or group of devices suitable for providing visual, auditory, or other suitable sensory output. Non-limiting examples of the presentation device 812 include a touchscreen, a monitor, a speaker, a separate mobile computing device, etc.

Although FIG. 8 depicts the presentation device 812 as being local to the computing device that executes the client computing system 106, other implementations are possible. For instance, in some embodiments, one or more of the presentation device 812 can include a remote client-computing device that communicates with the computing system 800 via the network interface device 810 using one or more data networks described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

1. A computer-implemented method in which a system performs operations comprising:
accessing data entries associated with a plurality of entities and obtained from a plurality of data sources;
generating a classification map for the plurality of entities by classifying the plurality of entities into a plurality of groups based on the data entries from the plurality of data sources, wherein the plurality of groups are arranged in the classification map according to values of the data entries of the plurality of entities;
determining one or more metrics for the plurality of groups;
determining a plurality of visualizations based on the classification map, each visualization representing one of the one or more metrics or the data entries from one of the plurality of data sources; and
generating, for inclusion in a user interface of the system, selectable interface elements configured for invoking an editing tool for updating the plurality of visualizations, wherein the selectable interface elements for the plurality of visualizations are arranged in the respective visualizations according to the classification map.

2. The method of claim 1, wherein each of the plurality of visualization comprises a two-dimensional arrangement of items, each item representing one of the plurality of groups, and wherein each item in one visualization has corresponding items in other visualizations of the plurality of visualizations.

3. The method of claim 2, wherein the operations further comprise:
receiving feedback from a selectable interface element in the user interface;
determining status of the items in the plurality of visualizations according to the feedback;
updating the plurality of visualizations according to the determined status; and
generating access control decisions for the plurality of entities based on the determined status of the items.

4. The method of claim 2, wherein the operations further comprise:
receiving feedback from a selectable interface element corresponding to one item in one of the plurality of visualizations in the user interface;
updating items in the plurality of visualizations that correspond to the one item according to the received feedback; and
generating access control decisions for the plurality of entities based on status of the items in the visualization.

5. The method of claim 1, wherein the operations further comprise:
determining respective weights for the plurality of data sources; and
updating the classification map by re-classifying the plurality of entities into the plurality of groups based on the data entries from the plurality of data sources and the respective weights for the plurality of data sources.

6. The method of claim 5, wherein re-classifying the plurality of entities into the plurality of groups comprises:
determining that a first data source has a higher weight than a second data source in the plurality of data sources;
scaling values of the data entries from the first data source to be within a first data range;
scaling values of the data entries from the second data source to be within a second data range, wherein the maximum value of the second data range is smaller than the maximum value of the first data range; and
re-classifying the plurality of entities into the plurality of groups based on the scaled values of the data entries from the plurality of data sources.

7. The method of claim 1, wherein the selectable interface elements comprise a selectable interface element configured for invoking an editing tool for updating a visualization for presenting a population for each group of the plurality of groups.

8. The method of claim 1, wherein the operations further comprise:
generating, for inclusion in the user interface of the system, additional selectable interface elements configured for invoking an editing tool for updating the plurality of visualizations, wherein each of the additional selectable interface elements corresponds to one of the plurality of data sources.

9. A system, comprising:
a processing device; and
a non-transitory computer-readable medium communicatively coupled to the processing device, wherein the processing device is configured to execute program code stored in the non-transitory computer-readable medium and thereby perform operations comprising:
accessing data entries associated with a plurality of entities and gathered from a plurality of data sources;
generating a classification map for the plurality of entities by classifying the plurality of entities into a plurality of groups based on the data entries from the plurality of data sources, wherein the plurality of groups are arranged in the classification map according to values of the data entries of the plurality of entities;
determining one or more metrics for the plurality of groups;
determining a plurality of visualizations based on the classification map, each visualization representing one of the one or more metrics or the data entries from one of the plurality of data sources; and
generating, for inclusion in a user interface of the system, selectable interface elements configured for invoking an editing tool for updating the plurality of visualizations, wherein the selectable interface elements for the plurality of visualizations are arranged in the respective visualizations according to the classification map.

10. The system of claim 9, wherein each of the plurality of visualization comprises a two-dimensional arrangement of items, each item representing one of the plurality of groups, and wherein each item in one visualization has corresponding items in other visualizations of the plurality of visualizations.

11. The system of claim 10, wherein the operations further comprise:
receiving feedback from a selectable interface element in the user interface;
determining status of the items in the plurality of visualizations according to the feedback;
updating the plurality of visualizations according to the determined status; and
generating access control decisions for the plurality of entities based on the determined status of the items.

12. The system of claim 10, wherein the operations further comprise:
receiving feedback from a selectable interface element corresponding to one item in one of the plurality of visualizations in the user interface;
updating items in the plurality of visualizations that correspond to the one item according to the received feedback; and
generating access control decisions for the plurality of entities based on status of the items in the visualization.

13. The system of claim 9, wherein the operations further comprise:
determining respective weights for the plurality of data sources; and
updating the classification map by re-classifying the plurality of entities into the plurality of groups based on the data entries from the plurality of data sources and the respective weights for the plurality of data sources.

14. The system of claim 13, wherein re-classifying the plurality of entities into the plurality of groups comprises:
determining that a first data source has a higher weight than a second data source in the plurality of data sources;
scaling values of the data entries from the first data source to be within a first data range;
scaling values of the data entries from the second data source to be within a second data range, wherein the maximum value of the second data range is smaller than the maximum value of the first data range; and
re-classifying the plurality of entities into the plurality of groups based on the scaled values of the data entries from the plurality of data sources.

15. The system of claim 9, wherein the selectable interface elements comprise a selectable interface element configured for invoking an editing tool for updating a visualization for presenting a population for each group of the plurality of groups.

16. A non-transitory computer-readable medium having program code that is stored thereon, the program code executable by one or more processing devices for performing operations comprising:
accessing data entries associated with a plurality of entities and gathered from a plurality of data sources;
generating a classification map for the plurality of entities by classifying the plurality of entities into a plurality of groups based on the data entries from the plurality of data sources, wherein the plurality of groups are arranged in the classification map according to values of the data entries of the plurality of entities;
determining one or more metrics for the plurality of groups;
determining a plurality of visualizations based on the classification map, each visualization representing one of the one or more metrics or the data entries from one of the plurality of data sources; and
generating, for inclusion in a user interface, selectable interface elements configured for invoking an editing tool for updating the plurality of visualizations, wherein the selectable interface elements for the plurality of visualizations are arranged in the respective visualizations according to the classification map.

17. The non-transitory computer-readable medium of claim 16, wherein each of the plurality of visualization comprises a two-dimensional arrangement of items, each item representing one of the plurality of groups, and wherein each item in one visualization has corresponding items in other visualizations of the plurality of visualizations.

18. The non-transitory computer-readable medium of claim 17, wherein the operations further comprise:
receiving feedback from a selectable interface element in the user interface;
determining status of the items in the plurality of visualizations according to the feedback;
updating the plurality of visualizations according to the determined status; and
generating access control decisions for the plurality of entities based on the determined status of the items.

19. The non-transitory computer-readable medium of claim 17, wherein the operations further comprise:
receiving feedback from a selectable interface element corresponding to one item in one of the plurality of visualizations in the user interface;
updating items in the plurality of visualizations that correspond to the one item according to the received feedback; and
generating access control decisions for the plurality of entities based on status of the items in the visualization.

20. The non-transitory computer-readable medium of claim 16, wherein the operations further comprise:
determining respective weights for the plurality of data sources; and
updating the classification map by re-classifying the plurality of entities into the plurality of groups based on the data entries from the plurality of data sources and the respective weights for the plurality of data sources.
